(19) United States
(12) Patent Application Publication
(10) Pub. No.: US 2025/0185672 A1
(43) Pub. Date: Jun. 12, 2025

(54) TWO PIECE BAKING PAN

(71) Applicant: Janet Snow, Sacramento, CA (US)

(72) Inventor: Janet Snow, Sacramento, CA (US)

(21) Appl. No.: 18/749,117

(22) Filed: Jun. 20, 2024

Related U.S. Application Data
(60) Provisional application No. 63/524,984, filed on Jul. 5, 2023.

(51) Int. Cl. A21B 3/13

(52) U.S. Cl. CPC A21B 3/132

(57) ABSTRACT

A two piece baking pan assembly is disclosed, including a top component releasably connectable to a bottom component. The bottom component is constructed as a baking pan having a plurality of reservoirs to receive a baked good therein. The top component includes a plurality of openings each corresponding to the plurality of reservoirs to permit a user to place raw baked goods through each of the plurality of openings into the plurality of reservoirs. The openings of the top component permit the baked goods to rise therethrough during baking and permit the efficient removal of the baked good following the baking process. Once baking is complete, the removal of the top component from the bottom component allows for the easy separation of the baked goods from the two piece baking pan.

### CROSS-REFERENCE TO RELATED APPLICATIONS

The present application claims priority to U.S. Provisional Application No. 63/524,984 filed Jul. 5, 2023, titled “TWO PIECE BAKING PAN,” which is hereby incorporated by reference in its entirety.

### TECHNICAL FIELD

Embodiments of the invention relate to baking accessories and more particularly to a two piece baking pan.

### BACKGROUND

Baking is a method of preparing food using heat supplied by an oven or heated surface. Common baked goods include bread, cookies, cakes, or other food items which are in the heating element. During the baking process, heat is transferred from the surface of the food item to the center to form a crust and soft center.

Baking pans and sheets are used to first deposit the raw food item on or in. The pan or sheet then forms a mold during the baking process to help the baked good maintain a desired shape. In particular cupcakes, muffins, miniature pies and other small pastries may be baked in pans which allow multiple baked items to be made at once. Once the baking process is completed, the baked good is then dislodged from the pan or sheet. Often, the dislodging process is done by hand, such as by removing each baked good individually, or flipping the pan or sheet upside down which, in either case, may cause damage.

### SUMMARY OF THE INVENTION

This summary is provided to introduce a variety of concepts in a simplified form that is disclosed further in the detailed description of the embodiments. This summary is not intended for determining or limiting the scope of the claimed subject matter.

The embodiments provided herein relate to a two piece baking pan assembly, including a top component releasably connectable to a bottom component. The bottom component is constructed as a baking pan having a plurality of reservoirs to receive a baked good therein. The top component includes a plurality of openings each corresponding to the plurality of reservoirs to permit a user to place raw baked goods through each of the plurality of openings into the plurality of reservoirs. The openings of the top component permit the baked goods to rise therethrough during baking and permit the efficient removal of the baked good following the baking process.

The two piece baking pan assembly allows for efficient removal of the baked goods while reducing the likelihood that the baked goods will be damaged when removed from the baking pan. When ready to remove the baked goods, the user will disconnect the top component and bottom component, then lift the top component to separate it from the bottom component. The top component will lift the baked goods out of the bottom component and allow the user to move them to another location without damaging them. When the baked goods are set down in another area, the user will let go of the handles of the top sheet allowing it to fall to the counter. The user may then freely grab the baked goods and finish decorating as needed.

### BRIEF DESCRIPTION OF THE DRA WINGS

A more complete understanding of the embodiments, and the attendant advantages and features thereof, will be more readily understood by references to the following detailed description when considered in conjunction with the accompanying drawings wherein:

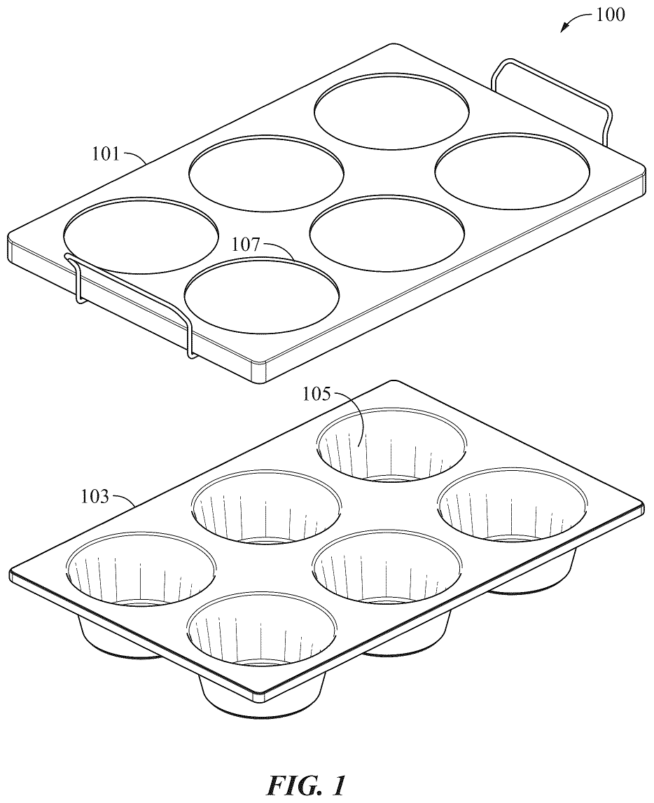

FIG. 1 illustrates a perspective view of the two piece baking pan wherein the top component and bottom component are separated, according to some embodiments;

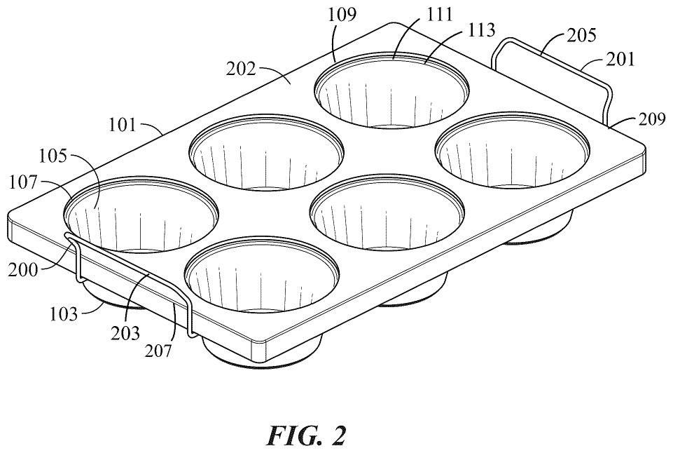

FIG. 2 illustrates perspective view of the two piece baking pan, according to some embodiments;

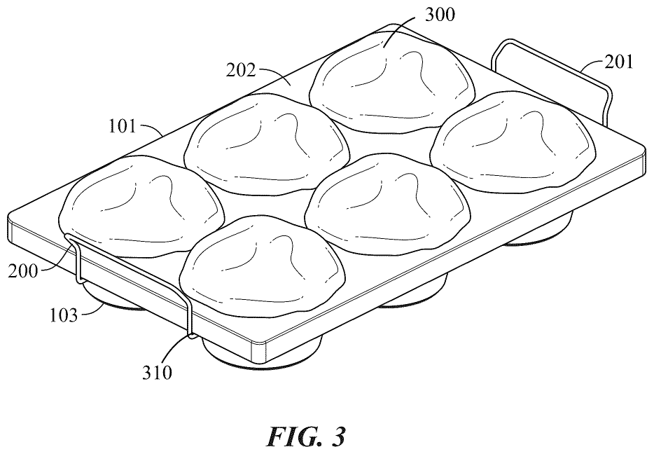

FIG. 3 illustrates a perspective view of the two piece baking pan and baked good positioned within the reservoirs of the baking pan, according to some embodiments;

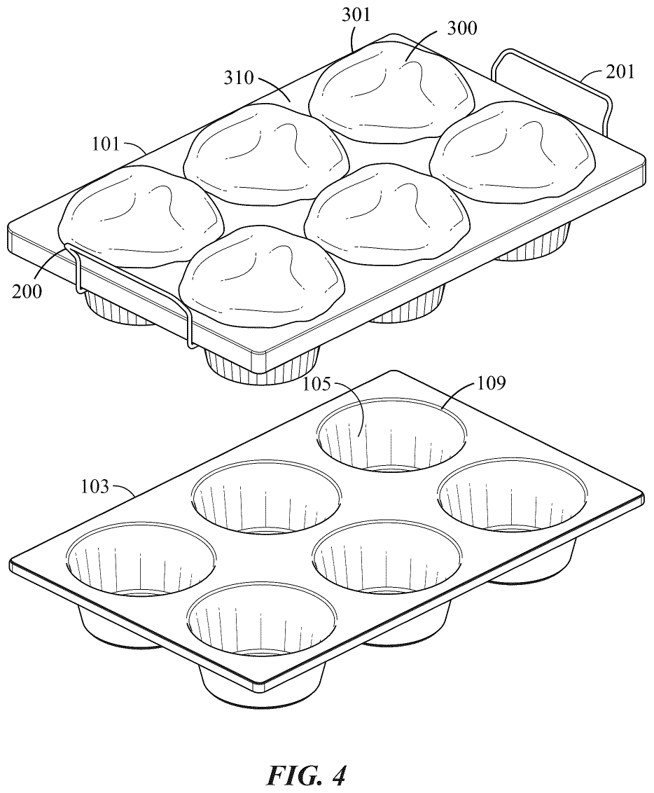

FIG. 4 illustrates a perspective view of the top component and baked good being removed from the bottom component, according to some embodiments; and

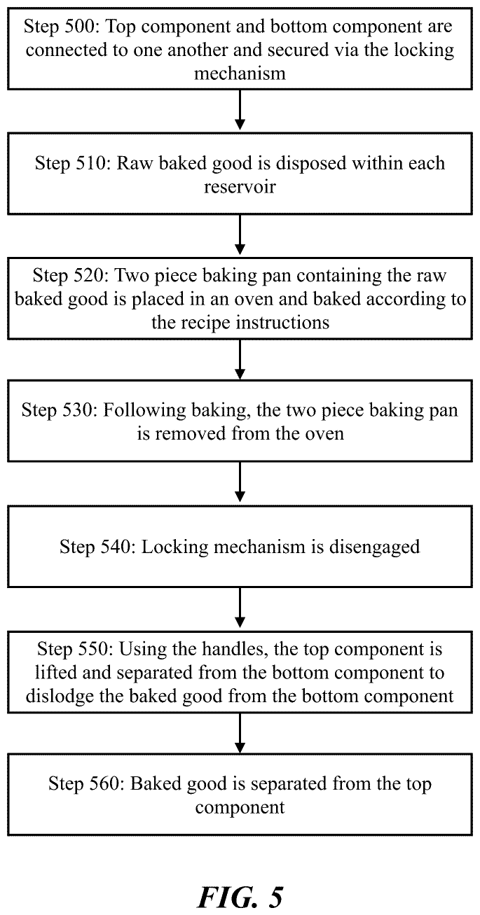

FIG. 5 illustrates a flowchart of a method of using the two piece baking pan, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relates to a two piece baking pan (which hereinafter will be referred to as “apparatus” or “the apparatus”) which allows for efficient removal of the baked good while reducing the likelihood that the baked goods will be damaged when removed from the baking pan.

FIG. 1 illustrates the apparatus 100 which includes a top component 101 and bottom component 103 separated from one another. The bottom component 103 is configured as a traditional baking pan having a plurality of reservoirs 105 to receive raw material prior to the baking process. The top component 101 includes a plurality of openings 107 configured to correspond to the reservoirs 105 when the top component 101 and bottom component 103 are aligned, such that raw baking goods may be poured through the openings 107 and into the reservoirs 105 such that individual baking goods are formed.

In some embodiments, the top component 101 is constructed of a non-stick coated metal or silicone to allow the baked good to be readily removed from the baking pan once the baking process is complete.

FIG. 2 illustrates perspective view of the baking pan having the top component 101 and bottom component 103 connected with one another. The top component 101 releasably engages with the bottom component 103 prior to depositing the baked good through the openings 107 and into the reservoirs 105. The user positions the top component 101 over the bottom component 103 and connects them via handles 200 to hold the top component 101 and bottom component 103 in position throughout the baking process. While in the oven, the baked good will rise as normal, and the top portion of the baked goods will flow over and sit on the top surface 202 of the apparatus 100.

When done baking, the user will pull the apparatus 100 out of the oven. When ready to remove the baked goods, the user will disconnect the top component 101 and bottom component 103, then lift the top component 101 to separate it from the bottom component 103. The top component 101 will lift the baked goods out of the bottom component 103 and allow the user to move them to another location without damaging them. When the baked goods are set down in another area, the user will let go of the handles 200,201 of the top sheet allowing it to fall to the counter. The user may then freely grab the baked goods and finish decorating as needed.

In some embodiments, the handles 200,201 allow for the top component 101 and the bottom component 103 to be releasably connected to one another. In such, the handles 200,201 allow the user to readily connect and disconnect the top component 101 and bottom component 103 as needed throughout the baking process. The first handle 200 may be positioned at a first side 207, and the second handle 201 is positioned at a second side 209.

In some embodiments, each handle 200,201 may include a heat resistant cover 203,205 such that the handles 200,201 can be held without burning the user's hands. The heat resistant covers 203,205 may be any known material having heat resistant properties, such as silicone.

The reservoirs 105 include an edge 109 defined by the first circumference 111. Once baked, the baked good protrudes over the edge 109 such that the baked good contacts the top surface 202. A second circumference 113 defined by the edge of the openings 107 is similar to the dimensions of the first circumference 111. This allows the baked good to be easily removed from the bottom component 103 following the baking process (as shown and described in FIGS. 3-4).

FIG. 3 illustrates a perspective view of the two piece baking pan 100 and baked good 300 positioned within the reservoirs 105 of the two piece baking pan 100. The baked good 300, once baked, expands and protrudes over the edge such that the perimeter 301 of the baked good 300 is greater than the perimeter (defining the edge) of the reservoirs 105. FIG. 4 illustrates a perspective view of the top component 101 and baked good 300 being removed from the bottom component 103. The baked good 300 expanding over the edge 109 allows for the user to grasp the first and second handles 200,201 and pull upwards to separate the top component 101 from the bottom component 103. This also removes the baked good 300 from the reservoirs 105, thus dislodging the baked good 300 from the bottom component.

To disconnect the top component 101 and bottom component 103, a locking mechanism 310 may be disengaged to release the top component 101 from the bottom component 103. The locking mechanism 310 may also be used to securely connect the top component 101 to the bottom component 103 when connected to one another.

In some embodiments, the locking mechanism 310 is capable of securing the top component 101 to the bottom component 103 using a clip which pivots to connect the top component 101 to the edge or rim of the bottom component 103. In another example, the locking mechanism 310, may increase friction between the top component 101 and the bottom component 103, in such providing a friction-fit therebetween. In another embodiment, the locking mechanism 310 may be configured as a locking clasp, such that the user engages a pivoting lock to secure the top component 101 to the bottom component 103.

FIG. 5 illustrates a flowchart of a method of using the two piece baking pan. In step 500, the top component and the bottom component are connected to one another and may be optionally secured together using the locking mechanism. In step 510, the raw baked good is disposed within one or more reservoirs. In step 520, the two piece baking pan containing the raw baked good is placed in an oven and baked according to the recipe instructions associated with the baked good. In step 530, once baking is complete, the two piece baking pan and baked good are removed from the oven. In step 540, the user disengages the locking mechanism. In step 550, the user utilizes the first and second handles to pull upwards, disconnecting the top component from the bottom component and, in such, removing the baked good from the reservoirs of the bottom component. In step 560, the user may then easily remove the baked good from the top component.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect. Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A two piece baking pan assembly, comprising:
a top component releasably connectable to a bottom component, the bottom component constructed as a baking pan having a plurality of reservoirs to receive a baked good therein, the top component having a plurality of openings each corresponding to the plurality of reservoirs to permit a user to place a raw baked good through each of the plurality of openings into the plurality of reservoirs,
wherein the plurality of openings of the top component permit the raw baked good to rise therethrough during baking and permit the efficient removal of the baked good following the baking process.

2. The two piece baking pan assembly of claim 1, further comprising at least one locking mechanism to lockingly engage the top component to the bottom component.

3. The two piece baking pan assembly of claim 2, wherein each of the at least one locking mechanisms are comprised of a clip to secure the top component to the bottom component.

4. The two piece baking pan assembly of claim 1, wherein the top component and the bottom component are each constructed of a non-stick material.

5. The two piece baking pan assembly of claim 1, wherein the plurality of reservoirs provide a reservoir wherein the raw baked good is disposed.

6. The two piece baking pan assembly of claim 1, further comprising a first handle positioned on a first side of the top component and a second handle positioned on a second side of the top component.

7. The two piece baking pan assembly of claim 6, wherein the first handle and the second handle each include a heat resistant cover.

8. The two piece baking pan assembly of claim 1, wherein the bottom component is provided as a part of a set, wherein the set includes a plurality of bottom components, wherein each of the plurality of bottom components includes a reservoir having a unique shape and a unique size to permit the baking of various baked goods.

9. The two piece baking pan assembly of claim 1, wherein a first circumference each of the plurality of reservoirs each corresponds to a second circumference defining each of the plurality of openings.

10. The two piece baking pan assembly of claim 1, wherein the top component includes a top surface, the top surface comprising each of the plurality of openings, wherein the top surface contacts the expanded baked good following the baking process to permit the efficient removal of the baked good.

11. A two piece baking pan assembly, comprising:
a top component releasably connectable to a bottom component via at least one handle at each end, the bottom component constructed as a baking pan having a plurality of reservoirs to receive a baked good therein, the top component having a plurality of openings each corresponding to the plurality of reservoirs to permit a user to place a raw baked good through each of the plurality of openings into the plurality of reservoirs,
wherein the plurality of openings of the top component permit the raw baked good to rise and expand over an edge during baking and permit the efficient removal of the baked good following the baking process.

12. The two piece baking pan assembly of claim 11, further comprising at least one locking mechanism to lockingly engage the top component to the bottom component.

13. The two piece baking pan assembly of claim 12, wherein each of the at least one locking mechanisms are comprised of a clip to secure the top component to the bottom component.

14. The two piece baking pan assembly of claim 11, wherein the top component and the bottom component are each constructed of a non-stick material.

15. The two piece baking pan assembly of claim 11, wherein the plurality of reservoirs provide a reservoir wherein the raw baked good is disposed.

16. The two piece baking pan assembly of claim 11, further comprising a first handle positioned on a first side of the top component and a second handle positioned on a second side of the top component.

17. The two piece baking pan assembly of claim 16, wherein the first handle and the second handle each include a heat resistant cover.

18. The two piece baking pan assembly of claim 11, wherein the bottom component is provided as a part of a set, wherein the set includes a plurality of bottom components, wherein each of the plurality of bottom components includes a reservoir having a unique shape and a unique size to permit the baking of various baked goods.

19. The two piece baking pan assembly of claim 11, wherein a first circumference of each of the plurality of reservoirs each corresponds to a second circumference defining each of the plurality of openings.

20. A method for utilizing a two piece baking pan, the method comprising the steps of:
connecting a top component and a bottom component of a two piece baking pan;
securing, via a locking mechanism, the top component to the bottom component;
disposing a raw baked good into one or more of a plurality of reservoirs;
placing the two piece baking pan containing the raw baked good into an oven and baking the raw baked good;
removing the two piece baking pan from the oven;
disengaging the locking mechanism;
lifting, using a first handle and a second handle, the top component from the bottom component to dislodge a baked food from the plurality of reservoirs;
separating the baked good from the top component.
